(19) United States
(12) Patent Application Publication
(10) Pub. No.: US 2011/0024928 A1
(43) Pub. Date: Feb. 3, 2011

(54) Patterned volume diffuser elements

(75) Inventor: Thomas M. Laney, Spencerport, NY (US)

Correspondence Address: Edwin Oh;Rohm and Haas Electronic Materials LLC, 455 Forest Street, Marlborough, MA, 01752, US

(73) Assignee: SKC Haas Display Films Co., Ltd., Cheonan-si (KR)

(21) Appl. No.: 12/462,252

(22) Filed: Jul. 31, 2009

(51) Int. Cl. G02F 1/01; G02F 1/361

(52) U.S. Cl. 264/1.31

(57) ABSTRACT

The present invention provides a method for manufacturing an optical diffuser element comprising: a) inserting striping shims in at least one flow passage of a multi-manifold extrusion die; b) extruding a first layer of polymer with light scattering particles through the flow passage with the striping shim to create linear domains of varying diffusion; c) extruding a second layer of polymer with less diffusion than the linear domains of varying diffusion through the manifold without a striping shim; and d) extruding the first and second layers of polymer into a dual roller nip with microstructure engravings in at least one roller.

### FIELD OF THE INVENTION

The present invention relates to a liquid crystal display (LCD) device, and more particularly, to an optical diffuser film that is capable of reducing the thickness of an LCD device as well as a method of fabricating the optical diffuser film.

### BACKGROUND

Liquid crystal displays (LCDs) are optical displays used in devices such as laptop computers, hand-held calculators, digital watches and televisions. Some LCDs include a light source that is located to the side of the display, with a light guide positioned to guide the light from the light source to the back of the LCD panel. Other LCDs, for example some LCD monitors and LCD televisions (LCD-TVs) are directly illuminated using a number of light sources positioned behind the LCD panel. This arrangement is increasingly common with larger displays, because the light power requirements, to achieve a certain level of display brightness, increase with the square of the display size, whereas the available real estate for locating light sources along the side of the display only increases linearly with display size. In addition, some LCD applications, such as LCD-TVs, require that the display be bright enough to be viewed from a greater distance than other applications, and the viewing angle requirements for LCD-TVs are generally different from those for LCD monitors and hand-held devices.

Some LCD monitors and most LCD-TVs are commonly illuminated from behind by a number of cold cathode fluorescent lamps (CCFLs). These light sources are linear and stretch across the full width of the display, with the result that the back of the display is illuminated by a series of bright stripes separated by darker regions. Such an illumination profile is not desirable, and so a diffuser plate is used to smooth the illumination profile at the back of the LCD device. Although the diffuser plate is very efficient at uniformizing the light intensity emitted from the CCFLs the diffuser plate typically must be positioned with a significant air gap between the CCFLs and the diffuser plate. Without this spacing the uniformity of the light begins to decay and brighter lines of luminance can be visually observed. Unfortunately, current trends in the market are requiring that LCD displays are made thinner. Therefore, it is desirable to reduce the space required between the diffuser plate and the CCFLs in order to thin the entire LCD display profile.

U.S. Patent Publication No. 2006/0285352 ('352 Patent) describes one approach to reducing the thickness a direct lit LCD back light unit by incorporating diffusive beads into the diffuser plate with varying concentration in the width direction corresponding to the proximity to the light source. In particular, the '352 patent discloses an optical device for a light source in a liquid crystal display device that includes a diffuser plate including a first diffusion part and a second diffusion part such that the light source emits a first amount of light to the first diffusion part and a second amount of light to the second diffusion part, and a plurality of beads included in both the first diffusion part and the second diffusion part, wherein the density of the beads in the first diffusion part is different from that in the second diffusion part. The higher diffusion part that is aligned over the light sources is described to be uniform within the diffusion part and thus located throughout the thickness of the diffuser plate or even above the diffuser plate in a separate diffuser film placed above the diffuser plate.

It would be much more efficient if the higher diffusion part was located not only over the light sources but much closer to the light sources. In fact, placing the higher diffusion part under the diffuser plate immediately above the light source is most preferred. Additionally, controlling the thickness of the higher diffusion part such as to graduate the level of diffusion from the center of the light source in a direction normal to the light source in the plane of the diffuser plate is most preferred.

### SUMMARY OF THE INVENTION

The invention provides a method for manufacturing an optical diffuser element comprising: a) inserting striping shims in at least one flow passage of a multi-manifold extrusion die; b) extruding a first layer of polymer with light scattering particles through the flow passage with the striping shim to create linear domains of varying diffusion; c) extruding a second layer of polymer with less diffusion than the linear domains of varying diffusion through the manifold without a striping shim; and d) extruding the first and second layers of polymer into a dual roller nip with microstructure engravings in at least one roller.

The invention further provides a method for manufacturing an optical diffuser element comprising: a) wet coating linear domains of varying diffusion onto a substrate; b) extruding a polymer layer with less diffusion than the linear domains of varying diffusion onto a surface of the substrate; and c) simultaneously with the extruding, passing the combined polymer layer and the substrate with linear domains of varying diffusion into a dual roller nip with microstructure engravings or a polished surface in at least one roller.

### BRIEF DESCRIPTION OF THE DRAWINGS

FIG. 1 illustrates a typical back-lit liquid crystal display device that uses a diffuser plate;

FIG. 2 illustrates an optical diffuser film with linear domains of varying diffusion according to principles of the present invention;

FIG. 3 illustrates “striping shims” and their positioning in a multi-manifold extrusion die;

FIG. 4 illustrates a “striping shim” in a wet coating hopper;

FIG. 5 illustrates optical elements with outer layers of uniform diffusion with various optical microstructures arranged on the surfaces of the films;

FIG. 6 illustrates optical elements with various optical microstructures arranged on the surfaces of the films;

FIG. 7 illustrates optical elements with outer layers of uniform diffusion with various optical microstructures arranged on the surfaces of the films;

FIG. 8 illustrates an LCD backlight unit assembly utilizing the optical elements of the present invention;

FIG. 9 illustrates another embodiment of an LCD backlight unit assembly utilizing the optical elements of the present invention; and

FIG. 10 illustrates another embodiment an LCD backlight unit assembly utilizing the optical elements of the present invention.

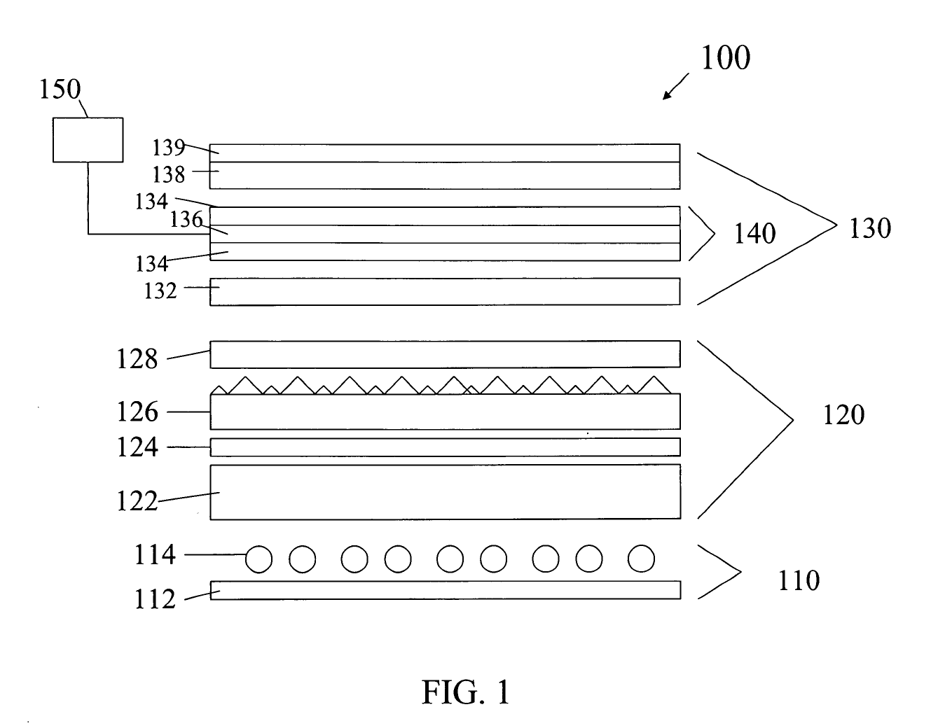

### DETAILED DESCRIPTION OF THE INVENTION

The invention is directed to a directly illuminated LCD device that has an arrangement of light management layers positioned between the LCD panel itself and the light source. The arrangement of light management layers includes at least one optical diffuser element comprising layers of linear domains of varying diffusion and comprising at least one layer of uniform diffusion wherein the at least one element has a microstructure pattern on one or more surface.

The optical diffuser films with linear domains of varying diffusion located near one or both surfaces of the diffuser film of the present invention are simple to manufacture and provide a high degree of flexibility in the materials and processes used in manufacturing. When located immediately above linear light sources, CCFLs for example, these films enable the typical light management layers used in a direct lit LCD backlight to be located much closer to the light sources.

The display device 100 is based on the use of a front panel assembly 130, comprising a LC panel 140, which typically comprises a layer of LC 136 disposed between panel plates 134. The plates 134 are often formed of glass, and may include electrode structures and alignment layers on their inner surfaces for controlling the orientation of the liquid crystals in the LC layer 136. The electrode structures are commonly arranged so as to define LC panel pixels, areas of the LC layer where the orientation of the liquid crystals can be controlled independently of adjacent areas. A color filter may also be included with one or more of the plates 134 for imposing color on the image displayed.

An upper absorbing polarizer 138 is positioned above the LC layer 136 and a lower absorbing polarizer 132 is positioned below the LC layer 136. The absorbing polarizers 138, 132 and the LC panel 140 in combination control the transmission of light from the backlight 110 through the display 100 to the viewer. One or more optional layers 139 may be provided over the upper absorbing polarizer 138, for example to provide mechanical and/or environmental protection to the display surface. In one exemplary embodiment, the layer 139 may include a hardcoat over the absorbing polarizer 138.

The backlight 110 includes a number of light sources 114 that generate the light that illuminates the LC panel 130. The light sources 114 used in a LCD-TV or LCD monitor are often linear, cold cathode, fluorescent tubes that extend across the display device 100. Other types of light sources may be used, however, such as filament or arc lamps, light emitting diodes (LEDs), flat fluorescent panels or external fluorescent lamps.

The backlight 110 may also include a reflector 112 for reflecting light propagating downwards from the light sources 114, in a direction away from the LC panel 140. The reflector 112 may also be useful for recycling light within the display device 100. The reflector 112 may be a specular reflector or may be a diffuse reflector. One example of a specular reflector that may be used as the reflector 112 is Vikuiti® Enhanced Specular Reflection (ESR) film available from 3M Company, St. Paul, Minn.

An arrangement 120 of light management layers is positioned between the backlight 110 and the front panel assembly 130. The light management layers affect the light propagating from backlight 110 so as to improve the operation of the display device 100. For example, the arrangement 120 of light management layers may include a diffuser plate 122. The diffuser plate 122 is used to diffuse the light received from the light sources, which results in an increase in the uniformity of the illumination light incident on the LC panel 140. Consequently, this results in an image perceived by the viewer that is more uniformly bright.

The arrangement 120 of light management layers may also include a reflective polarizer 128. The light sources 114 typically produce unpolarized light but the lower absorbing polarizer 132 only transmits a single polarization state, and so about half of the light generated by the light sources 114 is not transmitted through to the LC layer 136. The reflecting polarizer 128, however, may be used to reflect the light that would otherwise be absorbed in the lower absorbing polarizer, and so this light may be recycled by reflection between the reflecting polarizer 128 and the reflector 112. Any suitable type of reflective polarizer may be used, for example, multilayer optical film (MOF) reflective polarizers; diffusely reflective polarizing film (DRPF), such as continuous/disperse phase polarizers, wire grid reflective polarizers or cholesteric reflective polarizers.

The arrangement 120 of light management layers may also include a light directing film 126. A light directing film is one that includes a surface structure that redirects off-axis light in a direction closer to the axis of the display. This increases the amount of light propagating on-axis through the LC layer 136, thus increasing the brightness of the image seen by the viewer. One example is a prismatic light directing film, which has a number of prismatic ridges that redirect the illumination light, through refraction and reflection.

The arrangement 120 of light management layers may also include a light collimating diffuser film 124. A light collimating diffuser film is typically a polyester sheet coated with polymeric microbeads and a binder helps to re-direct off-axis light in a direction closer to the axis of the display.

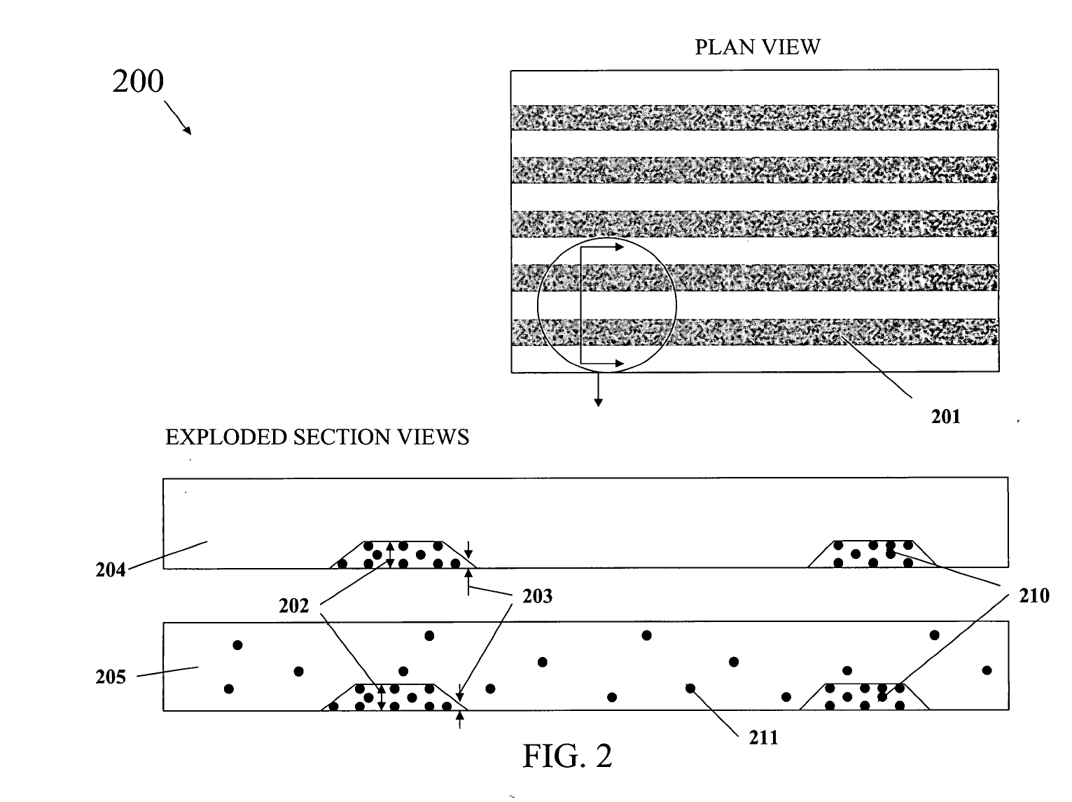

Unlike back light units used in conventional LCD-TVs, the present invention includes an optical diffuser film with linear domains of varying diffusion located near one or both surfaces of the diffuser film. The core layer, a continuous phase domain, comprises a lesser level of diffusion as compared to that of the linear domains at the surface of the film. One exemplary embodiment of the present invention is schematically illustrated in FIG. 2. The optical diffuser film 200 includes linear domains or stripes 201 near one of the film surfaces that have a relatively high concentration of optically scattering particles 210. The base or core layer which is a continuous domain can contain no light scattering particles, as in film 204, or can contain a lower concentration of particles than that of the linear domains, as in film 205. The linear domains at the surface are tapered such that the center of a linear domain 202 is thicker than the edge of the linear domain 203. This taper is useful when the film is placed above a linear light source since it diffuses light more near the light source where the light intensity is highest and gradually diffuses the light less further from the light source where the light intensity is lower. This helps to uniformize the light emitted from the diffuser on the surface opposite the light source.

The diffuser film 200 is preferably polymeric. Suitable polymer materials used to make the diffuser films may be amorphous or semi-crystalline, and may include homopolymer, copolymer or blends thereof. Example polymer materials include, but are not limited to, amorphous polymers such as poly(carbonate) (PC); poly(styrene) (PS); acrylates, for example acrylic sheets as supplied under the ACRYLITE® brand by Cyro Industries, Rockaway, N.J.; acrylic copolymers such as isooctyl acrylate/acrylic acid; poly(methylmethacrylate) (PMMA); PMMA copolymers; cycloolefins; cylcoolefin copolymers; acrylonitrile butadiene styrene (ABS); styrene acrylonitrile copolymers (SAN); epoxies; poly(vinylcyclohexane); PMMA/poly(vinylfluoride) blends; atactic poly(propylene); poly(phenylene oxide) alloys; styrenic block copolymers; polyimide; polysulfone; poly(vinyl chloride); poly(dimethyl siloxane) (PDMS); polyurethanes; poly(carbonate)/aliphatic PET blends; and semicrystalline polymers such as poly(ethylene); poly(propylene); poly(ethylene terephthalate) (PET); poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; and PET and PEN copolymers. Preferable polymers are polyesters and their copolymers. Most preferred are poly(ethylene terephthalate) (PET); poly(ethylene naphthalate)(PEN)polyesters and any of their copolymers. PET is most suitable as it is much lower in cost than PEN.

The light scattering or diffusing particles of the linear domains of varying diffusion can be any particle of different index of refraction from that of the polymer used in the layer containing the particle. These particles can be inorganic or organic. Inorganic particles can include any of calcium carbonate, barium sulfate, titanium dioxide, talc, or any other inorganic compound that can be melt blended into a polymer. Typical organic particles are cross-linked polymeric microbeads. Typically, these microbeads are acrylic but can be any polymer and are typically melt blended into a polymer. Alternatively, the organic particles can be any polymer that is immiscible with the matrix polymer. Resin pellets of these immiscible polymers can be simply dry blended with the resin pellets of the matrix polymer and extruded together to form a cast film. The light scattering particles typically range from 0.1 to 15.0 microns. Most preferably, they are between 1 and 6 microns.

The light scattering particles should be added so as to produce enough diffusivity to function as a diffuser and uniformize the light emitted from the diffuser film yet not be so opaque that the optical luminance of the LCD display is significantly reduced. Preferred loadings of the particles in the linear domain surface layers are 5 to 70 wt % of the matrix polymer used in that surface layer. The most preferred loadings are 15 to 40 wt % depending on the thickness of the film. The layers of uniform diffusion can also comprise light scattering or diffusion particles with a refractive index different from that of the continuous phase matrix polymer as described above. The preferable matrix polymer is polycarbonate and preferred light scattering particles are polymers with a refractive index between 1.53 and 1.64. Polymers with refractive index outside this range tend to over scatter light and make on-axis optical luminance when using these optical elements in optical systems to low.

The optical diffuser film 200 is preferably produced by a process of first mixing the matrix polymer and the light scattering particles. Mixing may be accomplished by mixing finely divided, e.g. powdered or granular matrix polymer and scattering particles and, thoroughly mixing them together, e.g. by tumbling them. The resulting mixture is then fed to the film forming extruder. Alternatively, blending may be effected by combining matrix polymer and the light scattering particles via separate material feeding equipment into a hopper and feeding a melt mixing extruder such as a twin screw extruder. In this case, the extrudate from the mixing extruder is typically cooled in a water bath and pelletized. The pellets are then subsequently extruded in a film forming process.

The extrusion, quenching, and in some cases stretching of the polymeric optical diffuser film is typically accomplished using a standard co-extrusion process with the addition of a unique surface striping concept. The process utilizes a standard 2 or 3 layer multi-manifold die. A 2 layer die is used to make a diffuser with linear diffusive domains on one surface, while a 3 layer die is used to make a film with linear diffusive domains on both surfaces. The film process involves first extruding the pre-mixed polymer, typically using one or two single screw extruders. Simultaneously, neat polymer or polymer blended with a lower concentration of light scattering particles, is extruded through another extruder. The melt flows from the extruders are piped to the multi-manifold die such that the melt with the higher concentration of light scattering particles is fed to one or two outer layers of the die, depending if a 2 or 3 layer multi-manifold die is used. The neat polymer melt, or polymer melt with the lower concentration of light scattering particles, is fed to the other outer layer or the center layer depending if a 2 layer or 3 layer multi-manifold die is used. Unique “striping shims” are installed in the one or two outer layers of the multi-manifold die so as to produce the linear domains or stripes in the extruded film.

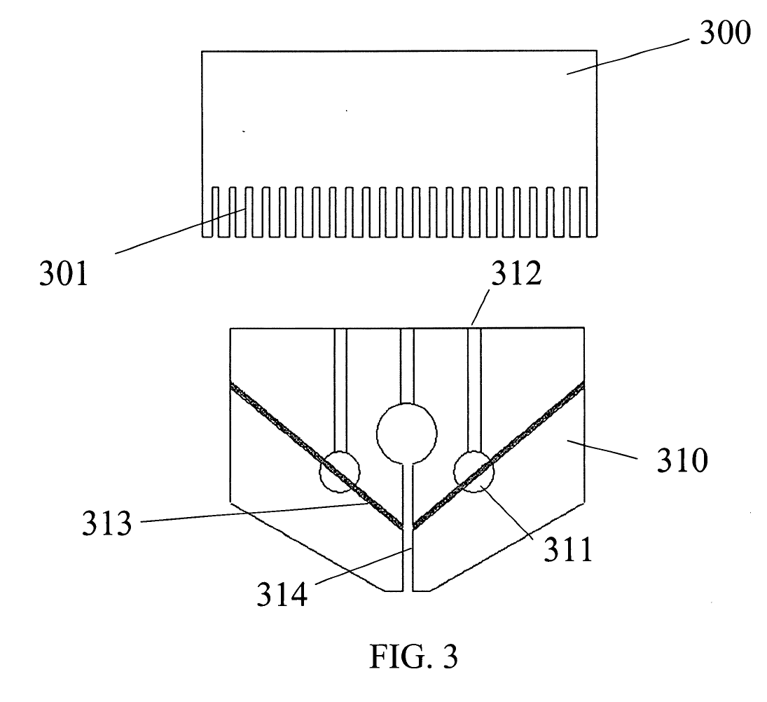

FIG. 3 illustrates the “striping shims” 300 and where they are positioned in the die 310. All flows are initially fed to the die through feed ports 312 on top of the die. The “striping shims” 300 are typically brass gaskets that are positioned between the two parts of the die which form the manifold 311 and internal slot 313. The “striping shims” can alternately be any means to provide periodic flow paths through the internal slots 313 of the die 310. They are installed in the manifolds to which the polymer melt with higher concentration of light scattering particles is fed. The “striping shims” 300 extend into the internal slot 313 of the multi-manifold die. The internal slot is the slot through which the polymer melt flows and converges with the other flows being fed to the die. The “striping shims” 300 are cut with periodic openings 301 in the area filling the internal slot 313. The part of the “striping shim” between the openings completely closes off the internal slot. The openings are sized in width to define the width of the subsequent linear domain being formed by the die. The periodic openings 301 are spaced such that the linear domains in the final film are centered directly over the array of linear light sources of the backlight in which the film is to be subsequently utilized.

As the polymer melt flows through the internal slots which the “striping shims” are positioned, the melt can only flow through the openings in the shim forming stripes that converge with the continuous flow of the core or base layer that is formed in a slot without a “striping shim”. The core or base layer comprises the melt which has less concentration of light scattering particles than the linear domains or stripes. The layers of polymer melt then exit the die through the final slot 314 after all the layers have converged. As the layered film exits the die, it is rapidly quenched upon a chilled casting drum so that the matrix polymer component of the film solidifies.

In a preferred embodiment where polyester is used as the matrix polymer, the film base is then biaxially oriented by stretching in mutually perpendicular directions at a temperature above the glass-rubber transition temperature of the matrix polymer. Generally the film is stretched in one direction first and then in the second direction although stretching may be effected in both directions simultaneously, if desired. In a typical process, the film is first stretched in the direction of extrusion over a set of rotating rollers or between two pairs of nip rollers and is then stretched in the direction transverse thereto by means of a tenter apparatus. The film may be stretched in each direction to 2.5 to 5.0 times its original dimension in each direction of stretching. Upon stretching, voids may initiate around the light scattering particles. The degree of any voiding is dependent upon the particle type, size, and concentration as well as the stretching temperature of the film and the ratio to which the film is stretched. Any voiding increases the degree of light scattering as the index of refraction of the gas in the void is much lower than the matrix polymer. The stretching can also enhance the degree of crystallinity of the polymer matrix of the film, thus making the film less prone to shrinking under test conditions. The final stretched thickness of the film is preferably in the 25 to 500 microns thickness range. The most preferred thickness range is between 50 to 250 microns. This is significantly thinner than diffuser plates used in conventional LCD backlights.

In the case of a polyester film comprising a crystalline polyester, like polyethylene-terphthalate (PET), after the film has been stretched and an optical diffuser film formed, it is heat set. Heat setting is done by heating to a temperature sufficient to crystallize the matrix polymer whilst restraining the voided polymeric optical diffuser against retraction in both directions of stretching. This process enables the film to meet shrinkage requirements of less than 1.0% when tested at temperatures up to 80° C.

The optical diffuser film 200 may also include optical brighteners that convert UV light into visible light. Such optical brighteners must be chosen from those which are thermally stable and can survive the extrusion temperatures or wet coating drying process used to fabricate the optical diffuser film. Preferred optical brighteners comprise benzoxazolyll-stilbene compounds. The most preferred optical brightener comprises 2,2′-(1,2-ethenediyldi-4,1-phenylene)bisbenzoxazole. These optical brighteners can be added to the film during the resin blending process and can be added via master batch pellets at the appropriate ratio. The appropriate ratio is that that would let down the concentration of the master batch pellet with the rest of the resin pellets to a concentration preferably between 0.01 and 0.1 wt %. In the most preferred embodiment the optical brightener will be added to attain a concentration between 0.02 and 0.05% wt.

The optical diffuser film 200 may also include an antistatic coating or conductive polymers within the films to prevent dirt attraction. Anyone of the known antistatic coatings or conductive polymers could be employed.

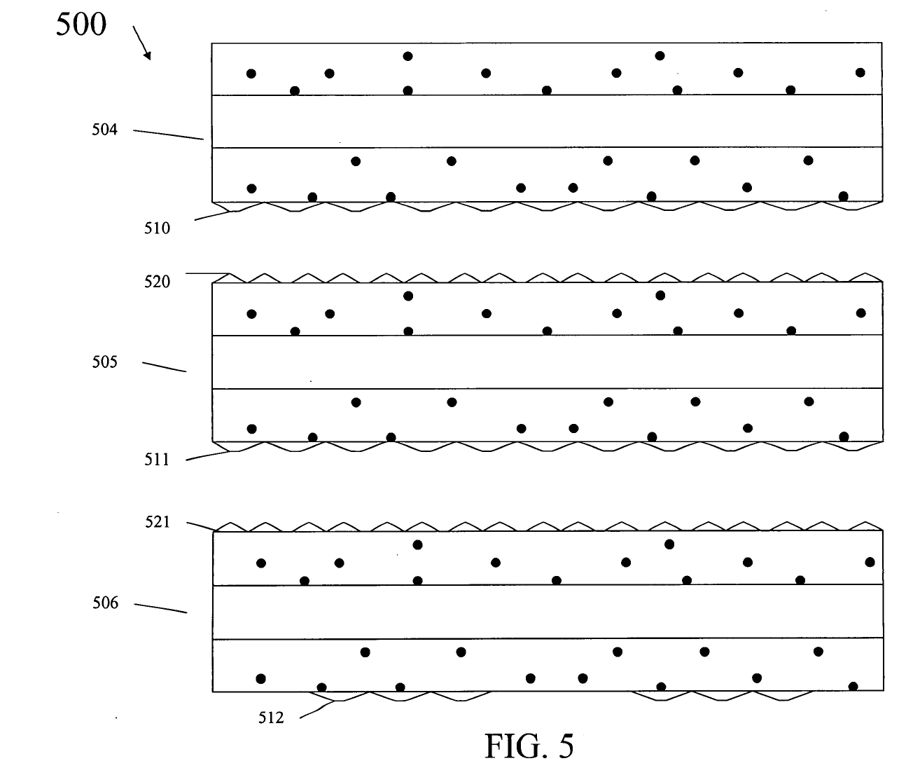

Referring now to FIG. 5, the optical element 500 includes a 3 layer laminate structure with continuous outer layers containing light scattering particles over a core substrate film. Suitable substrate films comprise, oriented polyesters, polycarbonate, or any other polymer with a Tg above 80° C. These optical elements have microstructures on the outer surfaces. In the case of optical element 504, the microstructures 510 are continuous and on one surface only. In the case of optical element 505, the microstructures 511 are continuous and on one surface while microstructures 520 are also continuous and located on the opposite surface. In the case of optical element 506, the microstructures 512 are discontinuous forming linear patches of microstructures that could be spaced to align with linear light sources when installed in an LCD backlight. Optical element 506 also has continuous microstructures 521 on the opposite surface.

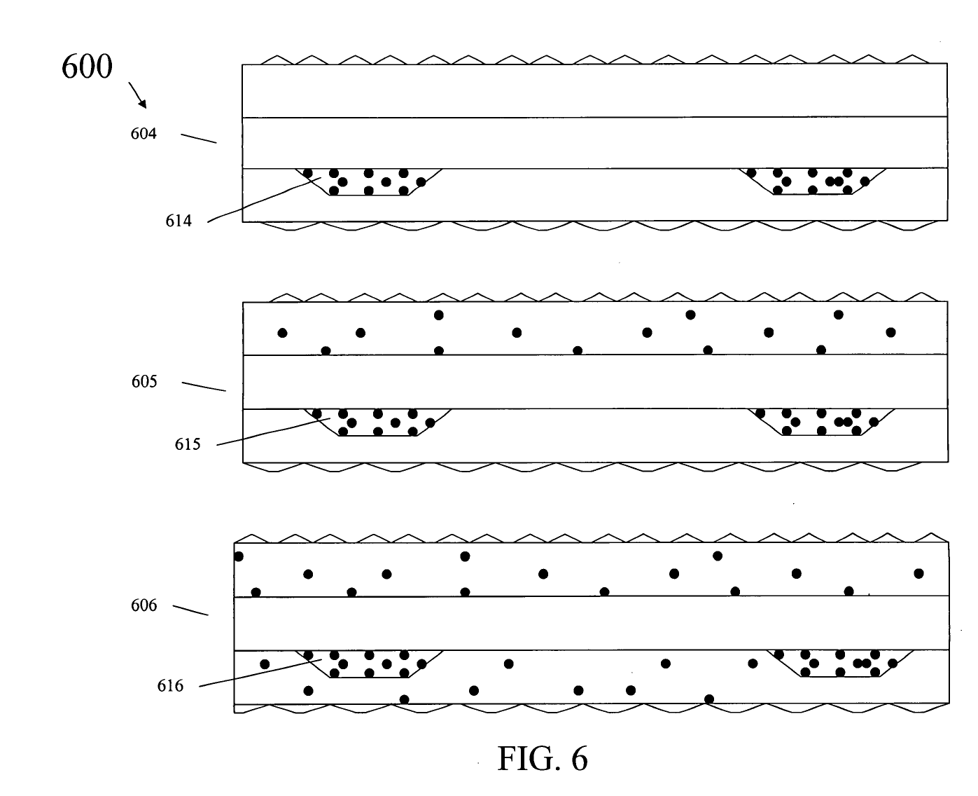

Referring now to FIG. 6, optical element 600 includes a 3 layer laminate structure with continuous outer layers over a core substrate film. These optical elements, however, comprise linear domains of varying diffusion 614, 615, and 616 that have a relatively high concentration of optically scattering particles located at the interface between one of the outer layers and the core substrate. These optical elements have microstructures on both the outer surfaces. In the case of optical element 604, neither of the outer layers comprises light scattering particles. In the case of optical element 605, the outer layer opposite the layer adjacent to the linear domains of varying diffusion is a continuous layer of uniform diffusion comprising light scattering particles. In the case of optical element 606, both outer layers have uniform diffusion and comprise light scattering particles.

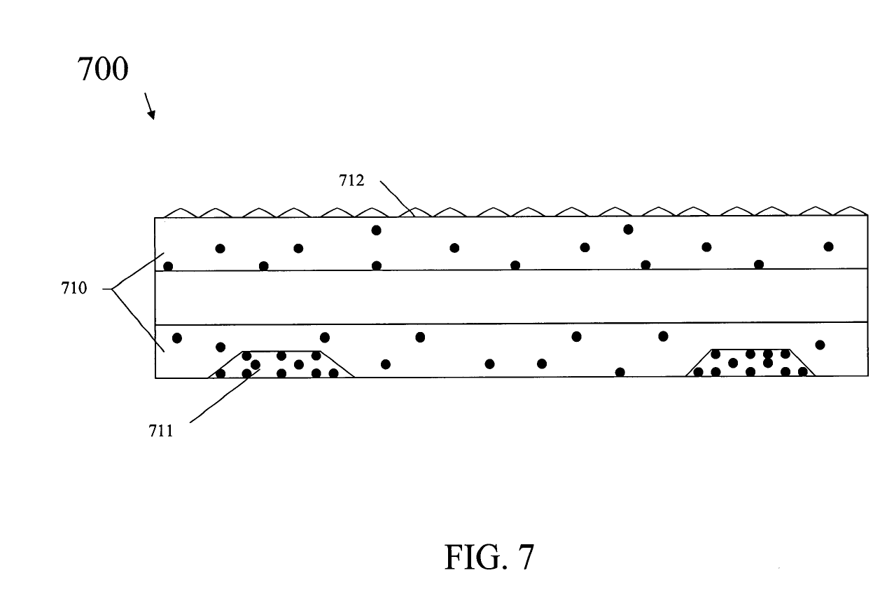

Referring now to FIG. 7, the optical element 700 includes a 3 layer laminate structure with continuous outer layers 710 over a core substrate film. These optical elements, however, comprise linear domains of varying diffusion 711 that have a relatively high concentration of optically scattering particles located at one of the outer surfaces of the optical element. These optical elements have microstructures 712 on the outer surface opposite the surface with the linear domains of varying diffusion. The continuous outer layers of uniform diffusion of optical element 700 comprise light scattering particles.

As described, the optical elements 500, 600, and 700 comprise microstructures on one or both surfaces. These microstructures can be prismatic, lenticular, or random structures which can be designed to attain a very uniform light emission from a series of linear light sources, even at very close spacing of the optical elements to the light sources. The microstructures can be linear patterns with uniform cross sections or discrete structures. All of the microstructures illustrated in FIGS. 5 through 7 can either comprise light scattering particles within the microstructures or the microstructures can be free of any light scattering particles.

The optical diffuser films 600 and 700 can be produced by a process of first mixing the matrix polymer and the light scattering particles as just described above for optical diffuser film 200. The mixed material is extruded in a multi-manifold die with striping shims in one manifold and a material with lower diffusion than the striped material extruded as a continuous layer through another manifold. The combined extruded layers are then coated onto a substrate core film with the linear domains of varying diffusion (or stripes) either adjacent the substrate or on the outer surface opposite the substrate. Another layer of material with less diffusion than the linear domains of varying diffusion from the first coated layer, but without linear domains itself, are then coated onto the opposite side of the substrate.

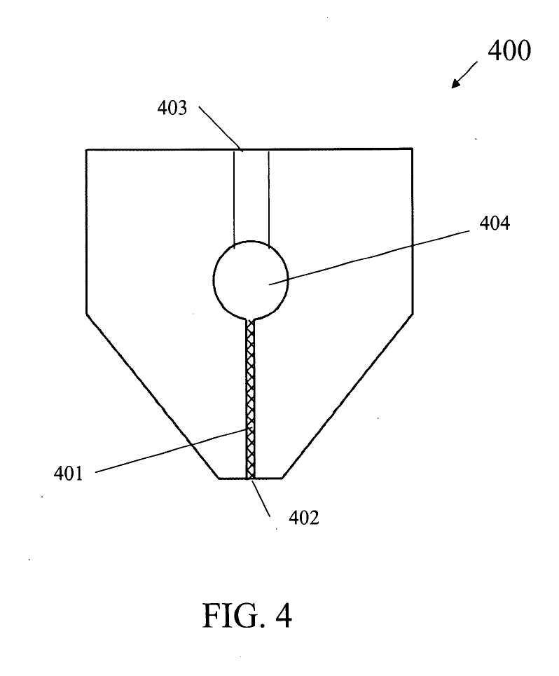

Alternatively, instead of co-extruding the linear domains of varying diffusion in the layers coated onto the substrate, the substrate can be pre-coated by a process of wet coating a coating solution comprising a binder polymer and a light scattering agent. The light scattering agent can be any inorganic or organic particles as those described previously for optical film 200. FIG. 4 shows a coating hopper 400 that can be used. Coating solution is fed into the hopper inlet 403 which feeds the hopper manifold 404. The hopper slot 402 is then fed by the manifold. Much like the extrusion die, the coating hopper utilizes a “striping shim” 401 in the coating slot 402 to form linear domains of coating solutions which are then coated onto a substrate. Typically the coated substrate then passes through a drying apparatus to dry the solution into solid domains.

In either case, the linear domains are coated as to provide a variation in the width wise thickness profile of the domains. Advantages of this widthwise thickness variation have been discussed previously in terms of a better uniformity of light intensity when the optical elements are utilized in a LCD backlight unit positioned over linear light sources. A dramatic decrease in light intensity at the edges of the light sources is thus prevented by this variation in thickness and thus light diffusion.

As each layer or set of layers are being extrusion coated onto the substrate for optical elements 600 and 700 the substrate and extruded layers pass through a dual roller nip. For surfaces with microstructures, engravings are cut in the roller making contact with the extruded polymer surface. For smooth surfaces, a roller with a polished surface is used against the extruded polymer surface.

Optical element 500 of FIG. 5 can be produced by the same extrusion method as described above for optical elements 600 and 700. In the case of the optical elements 500, however, no linear domains of varying diffusion are co-extruded into the outer extrusion coated layers nor wet coated onto the substrate film. The outer extrusion coated layers on the substrate do comprise light scattering particles forming continuous layers of uniform diffusion.

These continuous layers of uniform diffusion of optical elements 500 and 700 can also comprise light scattering or diffusion particles with a refractive index different from that of the continuous phase matrix polymer. The preferable matrix polymer is polycarbonate and preferred light scattering particles are polymers with a refractive index between 1.53 and 1.64.

The outer extruded layers of optical elements 500, 600, and 700 comprise matrix polymers which can include poly(carbonate); poly(styrene); acrylates, isooctyl acrylate/acrylic acid; poly(methylmethacrylate); cycloolefins; acrylonitrile butadiene styrene; styrene acrylonitrile copolymers; epoxies; poly(vinylcyclohexane); atactic poly(propylene); poly(phenylene oxide) alloys; polyimide; polysulfone; poly(vinyl chloride); poly(dimethyl siloxane) (PDMS); polyurethanes; poly(ethylene); poly(propylene); poly(ethylene terephthalate); poly(ethylene naphthalate); polyamide; ionomers; cellulose acetate; cellulose acetate butyrate; fluoropolymers; and copolymers and blends thereof.

The optical elements 500, 600, and 700 may also include optical brighteners that convert UV light into visible light. Such optical brighteners must be chosen from those which are thermally stable and can survive the extrusion temperatures or wet coating drying process used to fabricate the optical diffuser film. Preferred optical brighteners comprise benzoxazolyll-stilbene compounds. The most preferred optical brightener comprises 2,2′-(1,2-ethenediyldi-4,1-phenylene)bisbenzoxazole. These optical brighteners can be added to the film during the resin blending process and can be added via master batch pellets at the appropriate ratio. The appropriate ratio is that that would let down the concentration of the master batch pellet with the rest of the resin pellets to a concentration preferably between 0.01 and 0.1 wt %. In the most preferred embodiment the optical brightener will be added to attain a concentration between 0.02 and 0.05% wt.

The optical elements 500, 600, and 700 may also include an antistatic coating or conductive polymers to prevent dirt attraction. Anyone of the known antistatic coatings or conductive polymers could be employed.

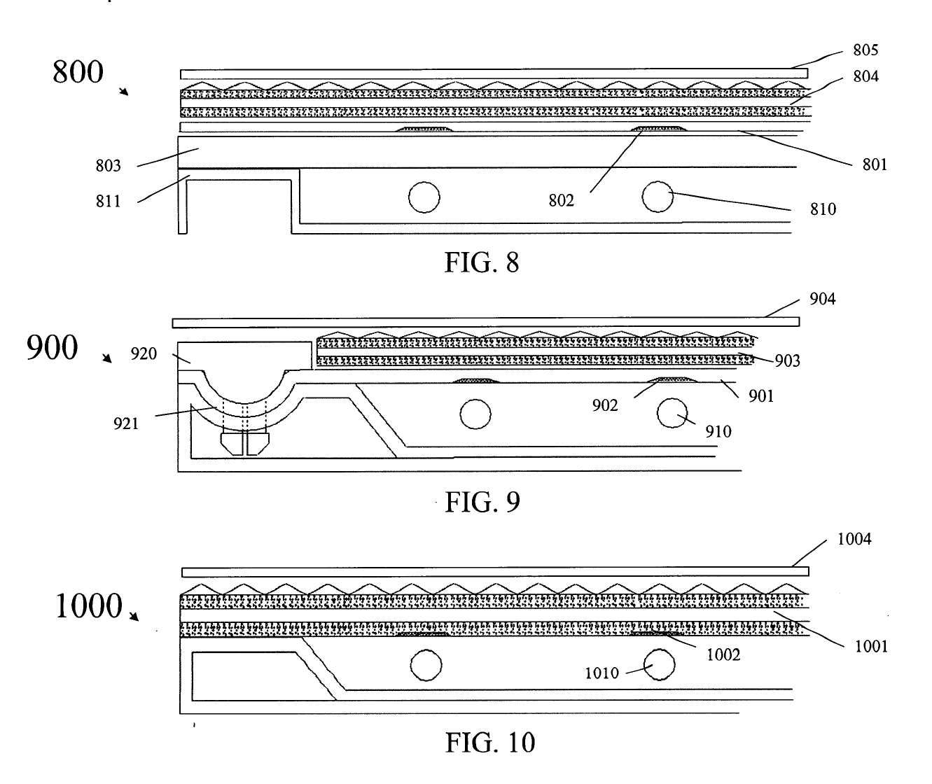

Referring now to FIG. 8, an LCD backlight assembly utilizing the optical diffuser element of the present invention is shown. The arrangement of light management layers in FIG. 8 includes an optical diffuser film 801 with linear domains of varying diffusion 802. Optical diffuser film 801 can be film 200 as described in FIG. 2. The optical diffuser film 801 is positioned immediately above linear light sources 810. In this embodiment, the optical diffuser film 801 is supported by a diffuser plate 803 positioned immediately below the optical diffuser film 801. The diffuser plate 803 is supported by a frame 811 of an LCD backlight unit.

A second optical element 804 is positioned above the optical diffuser film 801, opposite the diffuser plate. Optical element 804 can be optical element 500 as previously described in FIG. 5. Other optical films 805 can be added to the arrangement of light management layers above the optical element 804. These other optical films 805 may include a prismatic light directing film, a collimating diffuser film, or a reflective polarizer film.

The optical elements of the arrangement of light management layers 800 of FIG. 8 can be used in place of the diffuser plate and the optional optical films of conventional LCD displays enabling light management layers to be placed in closer proximity of the linear light sources. This closer proximity is enabled due to the initial uniformizing of the light emitted from the combination of the optical diffuser film 801 and the optical element 804. This enables the entire backlight unit and thus LCD to be made thinner.

FIG. 9 illustrates the arrangement of light management layers that includes an optical diffuser film 901 with linear domains of varying diffusion 902 located near one or both surfaces of the diffuser film. Optical diffuser film 901 can be film 200 as previously described in FIG. 2. The optical diffuser film 901 is positioned immediately above linear light sources 910. In this embodiment, the optical diffuser film 901 is supported by being tensioned between a crimping frame 920 and a groove in the frame of an LCD backlight 921. A second optical element 903 is positioned above the optical diffuser film 901, opposite the diffuser plate. Optical element 903 can be optical elements 500 as previously described in FIG. 5. Other optical films 904 can be added to the arrangement of light management layers above the optical element 903. These other optical films 904 may include a prismatic light directing film, a collimating diffuser film, or a reflective polarizer film.

FIG. 10 illustrates the arrangement of light management layers that includes a diffuser plate 1001 with linear domains of varying diffusion 1002 located within or near one surface of the diffuser plate. Diffuser plate 1001 can be anyone of the optical elements 600 or 700 as previously described. The diffuser plate 1001 is positioned immediately above linear light sources 1010. Other optical films 1004 can be added to the arrangement of light management layers above the diffuser plate 1001. These other optical films 1004 may include a prismatic light directing film, a collimating diffuser film, or a reflective polarizer film.

### EXAMPLE

An optical diffuser film with linear domains of varying diffusion located near both surfaces of the diffuser film was prepared. Also prepared was a laminate optical film with two layers of continuous diffusion and discrete prismatic microstructures on one surface. These two films were used together in combination with other light management layers in an LCD TV backlight and evaluated.

### EX-1

### Optical Diffuser Film with Linear Domains of Varying Diffusion

PET (#7352 from Eastman Chemicals) was melt mixed with 30% by weight of 2 μm polymethylsilsesquinoxane (PMSQ) microbeads (Tospearl 120A from General Electric). A Leistritz 27 mm twin screw extruder was used to melt mix the materials and the melt was subsequently cooled in a water bath and pelletized. These pellets along with a concentrate of TiO2 loaded at a nominal 50% by weight in PET (PET 9663 E0002 from Eastman Chemicals) were dried in desiccant dryers at 65° C. for 24 hours. Also, neat PET (#7352 from Eastman Chemicals) was dried in a desiccant dryer at 120° C. for 24 hours.

Striping shims (500 μm thick brass) were installed into the outside manifolds of a multi-manifold extrusion die as in FIG. 3. Both shims had slot openings that were spaced at 8 mm from center to center. One shim had openings that were 2.5 mm wide while the shim in the opposite manifold had shims with openings that were 0.8 mm wide.

Cast sheets were extruded using one 1″ extruder to extrude a blend of 40% neat PET (#7352 from Eastman Chemicals) and 60% of the concentrate pellets containing PMSQ microbeads. The second 1″ extruder was used to extrude a blend of a 20% by weight concentrate of the PET 9663 E0002 into PET (#7352 from Eastman Chemicals). Each extruder was piped to feed each of the two outside manifolds of FIG. 3, with the first 1″ extruder feeding the manifold with the 2.5 mm openings. A 1¼″ extruder was used to extrude neat PET (#7352 from Eastman Chemicals) into the center manifold of FIG. 3. All melt-streams were extruded at a temperature of 275° C. as fed into the extrusion die, also heated at 275° C. The relative flow rate of the three flows were as adjusted via melt pumps installed between each of the extruders and the die. The outside manifold with the shim having the 0.8 mm openings was fed a flow rate of 7.4 cc/minute. The outside manifold with the shim having the 2.5 mm openings was fed a flow rate of 20 cc/minute. The center manifold being fed neat PET was fed a flow rate of 82 cc/minute. As the extruded sheet emerged from the die, it was cast onto a quenching roll set at 55° C. The outer layers extrude as linear domains of high diffusivity as shown in FIG. 2. The final dimensions of the continuous cast sheet were 18 cm wide and 875 μm thick. The cast sheet was then stretched at 100° C. first 3.2 times in the X-direction (machine direction) and then 3.3 times in the Y-direction. The final film samples were 85 μm thick and cross section microscopy of the films showed that the linear domains of higher diffusion were formed at the surface of the films much like the film 204 of FIG. 2. The cross section of the linear domains had a taper with the center of the domain being thicker than the edge much like is shown in film 204 of FIG. 2.

Laminate Optical Film with Two Layers of Continuous Diffusion

A composite film sample like that of film 500 in FIG. 5 was made in an A/B/A film structure. The “A” layers comprised the amorphous PC homopolymer (Panlite® AD-5503 from Teijin Chemicals) with 10% by weight of Polyethylene Naphthalate (P100 from Invista Resins & Fibers GmbH, refractive index=1.62) added as diffusive particles or domains. The average particle or domain size was approximately 2 μm. The “B” layer was a 174 μm thick oriented PET film with adhesion layers on both sides. Each layer “A” was 163 μm thick resulting in a total film thickness of 500 μm. The sample was made in the process described above for film 500 of FIG. 5. The patterned structure on one surface comprised optical features whose geometry and processing was as that described in: U.S. patent application Ser. No. 10/868,083, to Brickey and entitled “Thermoplastic Optical Features with High Apex Sharpness”, filed Jun. 15, 2004; and U.S. patent application Ser. No. 10/939,769 to Wilson and entitled “Randomized Patterns of Individual Optical Elements, filed Sep. 13, 2004.

The optical diffuser film with linear domains of varying diffusion and the laminate optical film with two layers of continuous diffusion prepared as described above were installed into a backlight system like that of 900 described in FIG. 9. The optical diffuser film with linear domains of varying diffusion was located where film 901 is shown in FIG. 9. The narrower linear domains were facing the CCFLs 910 of FIG. 9 and the wider linear domains were aligned with the narrow domains but on the opposite surface. Both sets of linear domains were centered directly above the CCFLs. The laminate optical film with two layers of continuous diffusion was located where film 903 is shown in FIG. 9 with the patterned surface on the opposite side from the CCFLs 910. The other optical films 904 of FIG. 14 positioned adjacent film 903 were two bead coated collimation films (CH403 from SKC-Haas) and 1 light directing film (T280AF from SKC-Haas). The bead coated collimation films were placed immediately adjacent film 903 with the light directing film then placed adjacent the outer bead coated collimation film. The CCFLs used in the backlight were 4 mm in diameter and they were spaced 23 mm on center. The space between the top of the CCFLs and the bottom of film 901 as in FIG. 9 was 3 mm. In conventional direct lit backlights diffuser plate would be the first optical element spaced above the CCFLs and would be spaced greater than 15 mm from the CCFLs. This backlight system with the films as described by the present invention is therefore much thinner than a conventional direct lit backlight.

The measurements of brightness comprised a measure of uniformity and an on-axis luminance measurement. A description of the measuring equipment follows:

### Measurements:

The optical performance of the backlight was rated for on-axis luminance and luminance variability with the CCFLs set at maximum output. A TopCon BM7 colorimeter was used to measure both on-axis luminance and luminance variability for all samples. The 5 mm spot size of the instrument was swept perpendicularly across the CCFLs at a viewing angle of 90 degrees to the top films surface. This same measurement was made at 2 mm intervals and in 2 different locations along the length of the CCFLs. The average of all measurements determined the on-axis luminance. The average difference in the peak luminance directly above the CCFLs compared to the minimum luminance half way between CCFLs was also calculated. The percent luminance variation was determined by dividing the average difference by the on-axis luminance.

Table 1 shows the results of the on-axis luminance and luminance uniformity measurements of samples EX-1.

TABLE 1

| | | ON-AXIS |
|---|---|---|
| | LUMINANCE | LUMINANCE |
| TRIAL | VARIABILITY | cd/mm2 |
| EX-1 | 4% | 9700 |

It can be seen from Table 1 that the present invention as embodied in EX-1 offers excellent luminance uniformity with a very close spacing of the optical elements to the CCFLs. It also offers higher on-axis luminance. Both these values are typical of the performance of commercial LCD TV's today but which currently have much greater spacing between the CCFLs and the optical elements.

1. A method for manufacturing an optical diffuser element cormprising:
a) inserting striping shims in at least one flow passage of a multi-manifold extrusion die;
b) extruding a first layer of polymer with light scattering particles through the flow passage with the striping shim to create linear domains of varying diffusion;
c) extruding a second layer of polymer with less diffusion than the linear domains of varying diffusion through the manifold without a striping shim; and
d) extruding the first and second layers of polymer into a dual roller nip to formn a combined layer with microstructure engravings from at least one roller.

2. The method of claim 1 further comprising quenching the combined layer in a chilled casting drum.

3. The method of claim 2 further comprising stretching the combined layer to a thickness of between 25 to 500 microns.

4. The method of claim 3 further comprising heat setting the combined layer, the combined layer having shrinkage of less than 1.0% at temperatures of up to 80° C.

5. The method of claim 1 wherein the linear domains of varying diffusion comprise a layer of a matrix polymer and organic or inorganic light scattering particles wherein the layer is tapered such that the thickness at a center of a cross section of the linear domain is thicker than that at an edge of the linear domain.

6. The method of claim 5 wherein the light scattering particles are 0.1 to 15.0 microns.

7. The method of claim 1 wherein the diffuser element comprises poly(carbonate); poly(styrene); acrylates, isooctyl acrylate/acrylic acid; poly(methylmethacrylate); cycloolefins; acrylonitrile butadiene styrene; styrene acrylonitrile copolymers; epoxies; poly(vinylcyclohexane); atactic poly(propylene); poly(phenylene oxide) alloys; polyimide; polysulfone; poly(vinyl chloride); poly(dimethyl siloxane) (PDMS); polyurethanes; poly(ethylene); poly(propylene); poly(ethylene terephthalate); poly(ethylene naphthalate); polyamide; ionomers; cellulose acetate; cellulose acetate butyrate; fluoropolyrners; and copolymers and blends thereof.

8. A method for manufacturing an optical diffuser element comprising:
a) wet coating linear domains of varying diffusion onto a substrate;
b) extruding a polymer layer with less diffusion than the linear domains of varying diffusion onto a surface of the substrate; and
c) simultaneously with the extruding, passing the combined polymer layer and the substrate with linear domains of varying diffusion into a dual roller nip with microstructure engravings or a polished surface in at least one roller.

9. The method of claim 8 wherein the linear domains of varying diffusion comprise a layer of a matrix polymer and organic or inorganic light scattering particles wherein the layer is tapered such that the thickness at a center of a cross section of the linear domain is thicker than that at an edge of the linear domain.

10. The method of claim 9 wherein the light scattering particles are 0.10 to 15.0 microns.
